(19) United States
(12) Patent Application Publication
(10) Pub. No.: US 2024/0221997 A1
(43) Pub. Date: Jul. 4, 2024

(54) INSTRUMENT TRANSFORMER

(71) Applicant: Hitachi Energy Ltd, Zurich (CH)

(72) Inventors: Matteo CALAMARI, Vigolzone (IT); Michael GATZSCHE, Zürich (CH); Manuel NAEF, Rapperswil-Jona (CH); Max-Steffen CLAESSENS, Untersiggenthal (CH); Ulrich STRAUMANN, Winterthur (CH); Ennio ERRICO, Bariano (IT)

(21) Appl. No.: 18/288,740

(22) PCT Filed: Mar. 3, 2023
(86) PCT No.: PCT/EP2023/055450

§ 371 Date: Oct. 27, 2023

(30) Foreign Application Priority Data
Apr. 12, 2022 (EP) 22167909.5

(51) Int. Cl. H01F 27/32; H01F 27/02

(52) U.S. Cl. CPC H01F 27/321; H01F 27/02

(57) ABSTRACT

An instrument transformer of a type designed for using an insulation medium containing SF₆, said instrument transformer including a housing enclosing an insulation space and further including an electrical active part arranged in the insulation space, said insulation space containing a dielectric insulation medium. The instrument transformer is characterized in that the dielectric insulation medium contains a gaseous mixture including from 3 to 5 mol-% of heptafluoroisobutyronitrile, from 4 to 11 mol-% of oxygen (O₂) and from 84 to 93 mol-% of nitrogen (N₂).

### CROSS REFERENCE TO RELATED APPLICATIONS

This application is a 35 U.S.C. § 371 national stage application of PCT International Application No. PCT/EP2023/055450 filed on Mar. 3, 2023, which in turn claims foreign priority to European Patent Application No. 22167909.5, filed on Apr. 12, 2022, the disclosures and content of which are incorporated by reference herein in their entirety.

### BACKGROUND

The present disclosure relates to an instrument transformer.

Instrument transformers are well known in the art. Specifically, high voltage instrument transformers are designed to transform high current and high voltage levels down to low current and low voltage outputs in a known and accurate proportion specified by the end user. Apart from high voltage instrument transformers, instrument transformers also include current transformers and substation voltage transformers.

For the insulation of the electrically conductive parts contained in an instrument transformer, sulphur hexafluoride (SF₆) is conventionally used.

SF₆ is a well-established insulation gas due to its outstanding dielectric properties and its chemical inertness. Owed to the outstanding properties of SF₆ in terms of dielectric strength, existing instrument transformers are of relatively compact dimensions. A particularly compact design is achievable when SF₆ is used at a high pressure of 6 bar or above. This is owed to the very high dielectric performance achievable by SF₆ at high gas density, ultimately allowing for very small clearances within the instrument transformer.

Despite these properties, efforts to look for an alternative insulation gas have nevertheless been intensified, in particular in view of a substitute having a lower Global Warming Potential (GWP) than the one of SF₆.

In view of providing a non-SF₆ substitute, the use of organofluorine compounds in dielectric insulation media has been suggested.

Fluoroketones have been shown to have a high dielectric strength. At the same time, they have a very low GWP and very low toxicity. Owed to the combination of these characteristics, fluoroketones constitute a viable alternative to SF₆.

Despite their favourable properties in terms of environmental friendliness, the dielectric strength of the alternative insulation media discussed above is at operating conditions lower than the one of SF₆. For at least some of the proposed “non-SF₆” substitutes, this is due to their boiling point being relatively high. Hence, these alternative insulation media do not allow to reach the same performance level than when using SF₆ at the high pressure level mentioned above (i.e. 6 bar or above).

Although an increase of the performance level can in theory be achieved by increasing the pressure of the alternative insulation medium, this strongly increases the minimum operating temperature of the transformer, since at elevated pressure, unwanted condensation of the insulation medium or components thereof can occur at a higher temperature. On the opposite, when using an alternative insulation medium, the dielectric performance will be strongly reduced if the same minimum operating temperature as achievable when using SF₆ is to be reached.

In addition, increasing the pressure of the insulation medium can lead to the latter leaking out through gas sealing material conventionally used, such as EPDM. This is in particular the case for insulation media containing carbon dioxide, which is generally perceived to be a suitable carrier gas owed to its relative high dielectric strength and in particular its good arc quenching properties. For such carbon dioxide-containing insulation media, dedicated gas sealings (or other sophisticated means) must be applied to avoid leakage. Otherwise, a safe operation of the instrument transformer cannot be guaranteed.

Specifically, this problem can occur when using the gas mixture containing heptafluoroisobutyronitrile and carbon dioxide, which has been found to permeate through sealing components made of EPDM.

In consideration of the increasing need to reduce the use of SF₆ to a minimum, it would be desirable to replace existing SF₆-tailored instrument transformers by instrument transformers of improved environmental friendliness, in particular in view of a reduced GWP. However, for the reasons mentioned above, a replacement of SF₆ is currently not possible without compromising the safe operation of the transformer and/or without requiring substantial changes in the overall design of the transformer.

The problem to be solved by the present disclosure is thus to provide an instrument transformer of a type designed for using an insulation medium containing SF₆, which complies with the requirement of improved environmental friendliness, in particular a reduced GWP, but without compromising the safety of the transformer. In other words, the combined effect of improved environmental friendliness and similar insulation performance shall be achieved for the “SF₆-tailored” instrument transformer without requiring substantial changes in its design.

### SUMMARY

The problem is solved by the instrument transformer according to the independent claim. Embodiments of the disclosure are defined in the dependent claims.

According to an embodiment, the instrument transformer of the present disclosure is of a type designed for using an insulation medium containing SF₆.

Specifically, the instrument transfer is of the type designed for using SF₆ at a pressure of 5 bar absolute or above, such as 6 bar absolute or above. As mentioned above, an instrument transformer of this specific type has a very compact design owed to the small clearances achievable.

More specifically, the instrument transformer is one of a high voltage instrument transformer, a current transformer and substation voltage transformer, the latter having a rated output of above 200 VA per phase, such as of 200 VA to 333 kVA per phase.

### DETAILED DESCRIPTION

In some examples, the instrument transformer of the present disclosure is a high voltage instrument transformer. In the context of the present disclosure, “high voltage” refers to a voltage level range higher than 52 kV (in discrimination to “medium voltage” referring to a voltage level range from 1 kV to 52 kV).

In being of a type designed for using an insulation medium containing SF₆, the design and the dimension of the instrument transformer are adapted to the dielectric properties of SF₆, meaning that the components of which as well as their arrangement (including clearance distance between the components) are tailored to the use of SF₆. Instrument transformers of this type are well known to the skilled person. They are gas-tight with regard to SF₆ being present in the insulation space of the transformer.

In the instrument transformers of the type mentioned above, insulation spaces containing SF₆ are typically sealed using EPDM rubber (ethylene propylene diene monomer rubber) as sealing material. Instrument transformers of this type further have the ability of dissipating heat efficiently from the electrical components. The SF₆-containing medium used in these instrument transformers can be SF₆ in pure form, but also covers a medium in which apart from SF₆ impurities are present. Alternatively, the SF₆ containing-medium can also relate to a mixture containing SF₆ in combination with e.g. a carrier gas or a further dielectric compound. In the specific case of an instrument transformer designed for using an insulation medium containing or consisting of SF₆ at a pressure of at least 5 bar, this is reflected by a very compact design of the device, as mentioned above and as known to the skilled person.

The instrument transformer comprises a housing enclosing an insulation space and further comprises an electrical active part arranged in the insulation space, said insulation space containing a dielectric insulation medium.

According to the disclosure, the dielectric insulation medium of the disclosure contains a gaseous mixture comprising from 3 to 5 mol-% of heptafluoroisobutyronitrile, from 4 to 11 mol-% of oxygen (O₂) and from 84 to 93 mol-% of nitrogen (N₂)

It has surprisingly been found that by using a mixture as defined herein, an increased environmental friendliness can be achieved without compromising the safety and performance of the instrument transformer. In particular, it has been found that no significant change in the overall design of the instrument transformer and in the choice of components and materials used is required. This also applies to existing instrument transformers designed for using SF₆ at a pressure of 6 bar absolute at 20° C.; also for these instrument transformers, the mixture of the present disclosure allows the same insulation properties to be achieved than when using SF₆ at the pressure level mentioned.

Specifically, the present disclosure allows an instrument transformer to be achieved, which is of a lower GWP compared to a transformer of the same configuration but using an SF₆-containing medium.

In the context of the present disclosure, it has been found that by using an insulation medium as defined herein, a partial pressure of the heptafluoroisobutyronitrile can be achieved, which is higher than the partial pressure of the compound achievable in a gas mixture containing carbon dioxide at a total pressure to reach the same dew point or minimal operating temperature. Without wanting to be bound by the theory, the use of nitrogen in the fluoronitrile-containing gas mixture allows a Poynting effect to be achieved, which partly compensates the increase in the dew point resulting from the use of heptafluoroisobutyronitrile having a relatively high boiling point. In combination with the relatively high dielectric strength inherent to nitrogen, a dielectric insulation performance similar to the one of SF₆ can be achieved by the insulation medium according to the present disclosure.

In addition, it has been found that heptafluoroisobutyronitrile exhibits a high compatibility with other materials contained in the apparatus. In particular with regard to the sealing components typically used in an electrical apparatus using SF₆, the permeation rate of the insulation medium according to the present disclosure has been found to be relatively low. Thus, the dielectric insulation properties present in the insulation space can be maintained over time, which also contributes to the high safety of the apparatus re-established according to the present disclosure.

Ultimately, a replacement of an instrument transformer using SF₆ by an instrument transformer of improved environmental friendliness can be achieved, without requiring a change in the overall design of the transformer and in the choice of components and materials used, as mentioned above. The concept of the present disclosure is thus in clear distinction from the one disclosed in EP-A-3118955, according to which the design of the apparatus is changed in view of allowing a future switch from SF₆ to an eco-efficient insulation gas.

The technical effect achieved by the present disclosure is particularly pronounced if the amount of heptafluoroisobutyronitrile in the gaseous mixture is from 3.5 to 4.5 mol-%, such as about 4 mol-%.

According to an embodiment, the amount of oxygen (O₂) in the gaseous mixture is from 4 to 6 mol-%, such as about 5 mol-%.

According to a further embodiment, the amount of nitrogen (N₂) in the gaseous mixture is from 89.5 to 92.5 mol-%, such as about 91 mol-%.

All percentages refer to the total molar content of the gas mixture. In practice the preparation of gaseous mixtures is always subject to tolerances. Wherever ranges of gaseous mixtures are given, the ranges also cover the tolerances. Where no range is given, the value refers to the nominal value.

As mentioned above, the present disclosure allows the instrument transformer to be operated at low temperatures without facing the problem of condensation of the medium. In particular, the rated minimum operating temperature of the instrument transformer is −5° C. or lower, which in general applies for an indoor application of the instrument transformer. In the alternative case of an outdoor application, the rated minimum operating temperature of the instrument transformer may be −25° C. or lower, −30° C. or lower. For example, the rated minimum operating temperature for an outdoor application of the instrument transformer may be −30° C. but can also be −40° C., −50° C. or −60° C.

A specifically high insulation performance can be achieved for an instrument transformer, in which the dielectric insulation medium is present in the insulation space at a pressure ranging from 3 bar absolute to 12 bar absolute, such as from 3 bar absolute to 11 bar absolute, and/or from 8 bar absolute to 11 bar absolute, the pressure referring to a reference temperature of 20° C. It has surprisingly been found that even at these high pressure ranges, no or only negligible condensation of the insulation medium occurs.

As also mentioned above, the dielectric insulation medium of the present disclosure is favourable in view of a high compatibility with other material, in particular sealings, solid insulators and the like, contained in the instrument transformer in which it is to be used. In particular, the dielectric insulation medium is compatible with a sealing material selected from the group consisting of EPDM rubber and nitrile rubber typically used in an electrical apparatus designed for using SF₆, as well as with sealing material consisting of butyl rubber. For these sealing materials, also the permeation rate of the insulation medium according to the present disclosure has been found to be relatively low.

Specifically, a leakage rate of only 0.1%/y was measured for an EPDM sealing.

Typically, the sealing component sealing the insulation space is in the form of an O-ring. The sealing material used for the sealing component may be EPDM rubber (ethylene propylene diene monomer rubber) but can alternatively also be nitrile rubber and butyl rubber including unmodified butyl rubber and modified butyl rubber, especially chlorobutyl rubber (CIIR) or bromobutyl rubber (BIIR).

This is in particular the case if the dielectric insulation medium contains only a small amount of carbon dioxide or is devoid of carbon dioxide. According to an embodiment, the dielectric insulation medium thus contains less than 5 mol-% of carbon dioxide, such as less than 2 mol-% of carbon dioxide, and/or at least essentially devoid of carbon dioxide.

In consideration of the high material compatibility achievable by using the dielectric insulation medium of the present disclosure, the insulation space may be sealed by a sealing component comprising a sealing material selected from the group consisting of EPDM rubber, nitrile rubber and butyl rubber.

As also discussed above, it has been found that in combination with nitrogen, the fluoronitrile-containing insulation medium has a dew point, which is lower than the dew point of the fluoronitrile itself. In more concrete terms, dew point measurements of an alternative insulation medium containing heptafluoroisobutyronitrile in mixture with a carrier gas containing nitrogen and oxygen have revealed a dew point of −36° C., which is lower than the dew point of the isolated heptafluoroisobutyronitrile at the same partial pressure as used in the mixture (being at about −29° C.) and substantially lower than the dew point of a ternary mixture as the one defined above but using carbon dioxide instead of nitrogen (being at about −27° C.).

Owed to the low dew point of the dielectric insulation medium, the filling of the instrument transformer can be carried out on-site by directly introducing the gas mixture from a respective storage and transportation device. Hence, on-site commissioning is very simple and does not require sophisticated mixing means to prepare the composition containing the components in correct amounts.

The present disclosure is further illustrated by means of the following working example in connection with

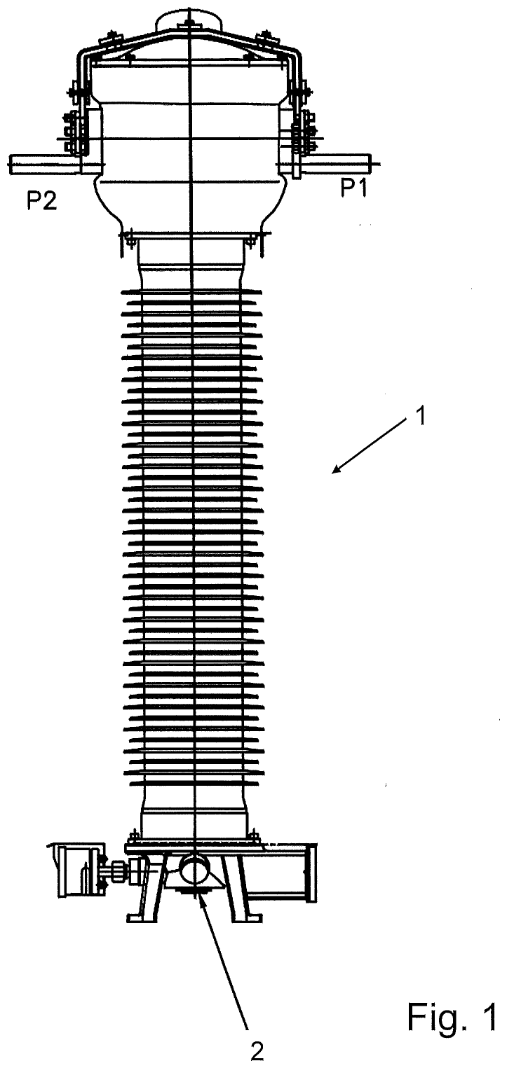

FIG. 1 showing a side view of an instrument transformer according to the present disclosure in the form of a current transformer;

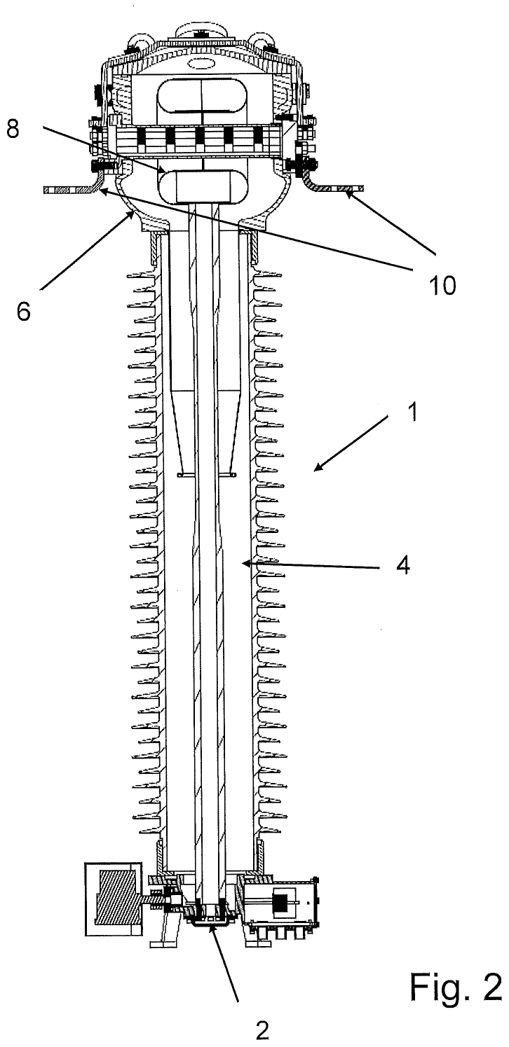

FIG. 2 showing the instrument transformer of FIG. 1 in longitudinal section through a first section plane; and

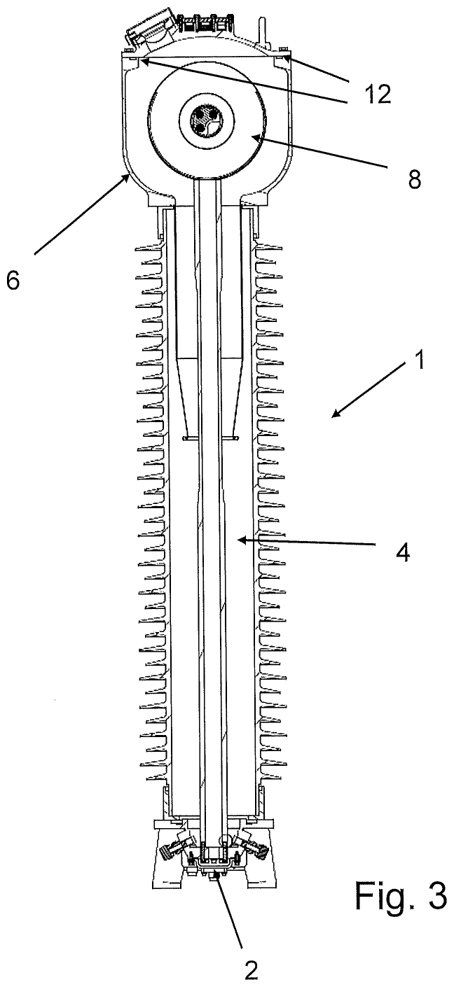

FIG. 3 showing the instrument transformer of FIG. 1 in longitudinal section through a second section plane.

### EXAMPLE

An instrument transformer designed for using SF₆ as dielectric insulation medium has been provided.

An alternative insulation medium containing 91 mol-% of nitrogen, 4 mol-% of heptafluoroisobutyronitrile and 5 mol-% of oxygen has then been filled into the insulation space by means of feed pipe connected to a respective filling valve in the housing enclosing the insulation space.

The instrument transformer thus filled successfully passed dielectric tests according to IEC regarding lightening impulse withstand voltage, switching impulse withstand voltage, power frequency withstand voltage and partial discharge measurement.

The dew point of the mixture was determined by constantly cooling down slowly the fluid and monitoring the respective pressure of the fluid, the drop in the pressure indicating the point where condensation starts. Thereby, a dew point of the mixture at −36° C. was determined, i.e. lower than the dew point of isolated heptafluoroisobutyronitrile at the same partial pressure, which is at −29° C.

The alternative gas mixture was further found to be compatible with most materials used in the instrument transformer designed for using SF₆ as dielectric insulation medium. Thus, no design change and major material change are necessary.

Regarding gas tightness, EPDM O-rings used as standard SF₆-sealing components in the apparatus have shown an acceptable degree of permeation of the alternative gas mixture used. Specifically, the permeation of nitrogen through the EPDM O-rings were found to be reduced by a factor of 7 compared to the permeation of carbon dioxide.

In the specific embodiment shown in FIG. 1, the insulation transformer (1) comprises a filling valve (2) at its bottom. Via this filling valve (2), the insulation medium is introduced into the insulation space (4) enclosed by the housing (6) to surround electrical active parts arranged in the insulation space, in particular a coil (8) and the portion of main conductor (10) arranged in the insulation space, as shown in FIGS. 2 and 3. The insulation space is sealed by a number of sealing components, of which a main sealing component (12) is shown in FIG. 3.

1. Instrument transformer of a type designed for using an insulation medium containing SF₆, said instrument transformer comprising a housing enclosing an insulation space and further comprising an electrical active part arranged in the insulation space, said insulation space containing a dielectric insulation medium, the dielectric insulation medium containing a gaseous mixture comprising from 3 to 5 mol-% of heptafluoroisobutyronitrile, from 4 to 11 mol-% of oxygen (O₂) and from 84 to 93 mol-% of nitrogen (N₂).

2. Instrument transformer according to claim 1, wherein the amount of oxygen (O₂) in the gaseous mixture is from 4 to 6 mol-%.

3. Instrument transformer according to claim 1, wherein the amount of heptafluoroisobutyronitrile in the gaseous mixture is from 3.5 to 4.5 mol-%.

4. Instrument transformer according to claim 1, wherein the amount of nitrogen (N₂) in the gaseous mixture is from 89.5 to 92.5 mol-%.

5. Instrument transformer according to claim 1, wherein its rated minimum operating temperature is −5° C. or lower.

6. Instrument transformer according to claim 1, wherein its rated minimum operating temperature is −30° C.

7. Instrument transformer according to claim 1, wherein the dielectric insulation medium is present in the insulation space at a pressure ranging from 3 bar absolute to 12 bar absolute.

8. Instrument transformer according to claim 1, wherein the instrument transformer is of the type designed for using SF₆ at a pressure of 5 bar absolute or above, preferably 6 bar absolute or above.

9. Instrument transformer according to claim 1, wherein the dielectric insulation medium contains less than 5 mol-% of carbon dioxide.

10. Instrument transformer according to claim 1, wherein the insulation space is sealed by a sealing component comprising a sealing material selected from the group consisting of EPDM rubber, nitrile rubber and butyl rubber.

11. Instrument transformer according to claim 1, wherein the instrument transformer is one of a high voltage instrument transformer, a current transformer and substation voltage transformer.

12. Instrument transformer according to claim 1, wherein the amount of oxygen (O₂) in the gaseous mixture is about 5 mol-%.

13. Instrument transformer according to claim 1, wherein the amount of heptafluoroisobutyronitrile in the gaseous mixture is about 4 mol-%.

14. Instrument transformer according to claim 1, wherein the amount of nitrogen (N₂) in the gaseous mixture is about 91 mol-%.

15. Instrument transformer according to claim 1, wherein the instrument transformer is of the type designed for using SF₆ at a pressure of 6 bar absolute or above.

16. Instrument transformer according to claim 1, wherein the dielectric insulation medium contains less than 2 mol-% of carbon dioxide.

17. Instrument transformer according to claim 1, wherein the dielectric insulation medium is at least essentially devoid of carbon dioxide.
